(19) United States
(12) Patent Application Publication
(10) Pub. No.: US 2018/0003541 A1
(43) Pub. Date: Jan. 4, 2018

(54) LIQUID SURFACE DETECTION APPARATUS AND MANUFACTURING METHOD OF SAME

(71) Applicant: DENSO CORPORATION, Kariya-city, Aichi-pref. (JP)

(72) Inventor: Naoto SUZUKI, Kariya-city (JP)

(21) Appl. No.: 15/537,332

(22) PCT Filed: Mar. 8, 2016
(86) PCT No.: PCT/JP2016/001233

§ 371 Date: Jun. 16, 2017

(30) Foreign Application Priority Data
Mar. 12, 2015 (JP) 2015-049817

(51) Int. Cl. G01F 23/62

(52) U.S. Cl. CPC G01F 23/62

(57) ABSTRACT

A terminal of a liquid surface detection apparatus includes: a connecting portion that is provided in a connecting area exposed from a body; a bent portion that is continuous with the connecting area while the bent portion is bent on a bending side where the connecting area is exposed; and a projecting wall portion that is formed continuously with the connecting area together with a side of a base of the bent portion, while the projecting wall portion projects in a form of a standing wall from the connecting area. The body includes an extending portion that is securely joined to: a fixing part of a side surface of the bent portion located on a counter-bending side of the bent portion that is opposite from the bending side of the bent portion; and a fixing part of the projecting wall portion.

### CROSS REFERENCE TO RELATED APPLICATION

The present application is based on and incorporates herein by reference Japanese Patent Application No. 2015-49817 filed on Mar. 12, 2015.

### TECHNICAL FIELD

The present disclosure relates to a liquid surface detection apparatus, which senses a liquid surface level of liquid stored in a container, and a manufacturing method thereof.

### BACKGROUND ART

Previously, there is known a liquid surface detection apparatus that senses a liquid surface level of liquid stored in a container. A liquid surface detection apparatus disclosed in the patent literature 1 includes a float, a sensor element and a body. The float floats on oil in an oil pan of an engine of a vehicle. The sensor element senses a position of the float. The body includes a dielectric portion made of a resin dielectric material and is formed integrally with a terminal connected with a lead line that outputs an electric signal of the sensor element with respect to the position of the float to an outside.

### CITATION LIST

### Patent Literature

PATENT LITERATURE 1: JP2014-235157A

In the patent literature 1, the oil in the inside of the oil pan is supplied to corresponding respective parts of the engine through an oil pump and is thereafter returned to the inside of the oil pan. A position of the body relative to the float is often set such that the oil, which is returned to the inside of the oil pan, does not contact the float to limit erroneous sensing caused by movement of the float that is induced by contacting of the oil, which is returned to the inside of the oil pan, to the float.

At the time of manufacturing such a liquid surface detection apparatus, when molten resin is injected into an inside of a resin molding die, in which the terminal is placed, to integrate the terminal with the body, it is encountered a disadvantage of that the resin material flows to a connecting portion of the terminal in the molding die due to presence of inaccurate sealing between the molding die and the terminal. That is, the terminal is formed such that an end part of a plate member, which is made of an electrically conductive material, is cut in a form of a projection, and this projection is bent to have a U-shaped cross section while the lead line is clamped in the inside of the bent portion of the terminal to connect between the lead line and the terminal. Since the terminal is bent to have the U-shaped cross section, wrinkles are formed at a side of the terminal due to the transformation of the shape in the U-shaped form. Therefore, sealing between the side of the terminal and the molding die becomes insufficient due to the presence of the wrinkles at the side of the terminal. Thereby, the molten resin flows into the inside of the bent portion through a gap between the wrinkles at the side of the terminal and the molding die. Thus, at the time of removing the body, to which the terminal is integrally molded with the molding die, from the molding die, the resin may remain at the terminal to interfere with the electrical connection between the terminal and the lead line to cause conduction failure. Thereby, in such a case, the measurement signal of the sensor element cannot be correctly outputted to the outside.

The inventor of the present application has studied about forming of a through-hole around a connecting portion of the body that is connected to the plate portion of the terminal, which is bent in the U-shaped form. Specifically, even when the molten resin tries to flow into the inside of the bent portion of the terminal through the gap between the wrinkles of the side of the terminal and the molding die, the flow of the molten resin is blocked by the through-hole, so that the resin does not flow to the connecting portion of the terminal. However, it has been found that the oil, which is returned from the oil pan, flows through the through-hole of the body and falls on the float to cause movement of the float, and thereby liquid surface level cannot be accurately sensed.

### SUMMARY OF INVENTION

The present disclosure is made in view of the above disadvantages, and it is an objective of the present disclosure to provide a liquid surface detection apparatus, which can accurately sense a liquid surface level, and a manufacturing method thereof.

In order to achieve the above objective, according to one aspect of the present disclosure, there is provided a liquid surface detection apparatus for sensing a liquid surface level of liquid stored in a container, the liquid surface detection apparatus including: a float that floats on the liquid; a sensor element that senses a position of the float; a terminal that is made of an electrically conductive material, wherein a lead line, which outputs a measurement signal of the sensor element to an outside, is connected to the terminal; and a body that is formed integrally with the terminal and includes a dielectric portion, which is made of a dielectric material, wherein: the terminal includes: a connecting portion that is provided in a connecting area of the terminal, which is exposed from the body; a bent portion that is continuous with the connecting area, wherein the bent portion is bent on a bending side where the connecting area is exposed, so that the lead line is connected between the bent portion and the connecting portion; and a projecting wall portion that is formed continuously with the connecting area together with a side of a base of the bent portion, wherein the projecting wall portion projects in a form of a standing wall from the connecting area; and the body includes an extending portion that is securely joined to: a fixing part of a side surface of the bent portion located on a counter-bending side of the bent portion that is opposite from the bending side of the bent portion; and a fixing part of the projecting wall portion; and the extending portion extends from the fixing part of the side surface of the bent portion and the fixing part of the projecting wall portion toward a side that is opposite from the connecting portion.

According to the above aspect, the body, which includes the dielectric portion made of the dielectric material, is formed integrally with the terminal that is made of the electrically conductive material. At the connecting portion of the terminal, the connecting area is exposed from the body. Here, the bent portion, which is continuous with the connecting area, is bent on the side where the connecting area is exposed, so that the lead line is connected between the bent portion and the connecting portion. When the lead line is connected between the connecting portion and the bent portion, the lead line is held in a manner that enables electrical conduction between the lead line and the terminal. Thereby, it is possible to limit the conduction failure.

In addition, the projecting wall portion, which projects in the form of the standing wall, is formed continuously with the connecting area together with the side of the base of the bent portion. With this projecting wall portion, even in the structure, in which the extending portion of the body is securely joined to the fixing part of the side surface of the bent portion located on the counter-bending side of the bent portion and the fixing part of the projecting wall portion, the inflow of the dielectric material from the counter-bending side to the connecting area is limited at the time of molding the body. Therefore, the connecting of the lead line in the state where the dielectric material is left is less likely to occur. Thus, the conduction failure is limited, and the measurement signal of the sensor element can be accurately outputted to the outside.

Since the extending portion, which is formable in the above described manner, extends toward the side that is opposite from the connecting portion, the liquid is less likely to pass through the body and fall on the float. Therefore, it is possible to limit influence of the movement of the float, which is caused by the falling of the liquid on the float, to the sensing result. Thus, the liquid surface level can be accurately sensed.

Furthermore, in order to achieve the above objective, according to another aspect of the present disclosure, there is provided a manufacturing method for manufacturing the liquid surface detection apparatus through use of a molding die that molds the body, including: a positioning step of positioning the molding die such that the molding die contacts to an opposite side of the projecting wall portion, which is opposite from the connecting portion; and an injecting step of injecting the dielectric material to the counter-bending side after the positioning step.

According to the above aspect, once the molding die is positioned such that the molding die contacts the opposite side of the projecting wall portion, which is opposite from the connecting portion, the dielectric material is injected to the counter-bending side. Thereby, the body is molded. In this way, at the time of injecting the dielectric material, the molding die contacts the projecting wall portion on the side that is opposite from the connecting portion. Therefore, it is possible to form the extending portion, which is securely joined to the counter-bending side of the projecting wall portion, while limiting the inflow of the dielectric material to the connecting portion beyond the projecting wall portion. In the liquid surface detection apparatus, which is manufactured in the above described manner, it is possible to limit the conduction failure, and the liquid is less likely to pass through the body and fall on the float. Thus, the liquid surface level can be accurately sensed.

### BRIEF DESCRIPTION OF DRAWINGS

The present disclosure, together with additional objectives, features and advantages thereof, will be best understood from the following description in view of the accompanying drawings.

FIG. 1 is a diagram showing a state where a liquid surface detection apparatus according to an embodiment is placed in an inside of an oil pan.

FIG. 2 is a frontal cross sectional view indicating a main unit according to the embodiment.

FIG. 3 is a top view of the main unit and a wire taken in a direction of an arrow III in FIG. 2.

FIG. 4 is a partial enlarged perspective view schematically showing an area around a connecting portion that corresponds to a lead according to the embodiment.

FIG. 5 is an enlarged cross sectional view, which is taken along line V-V in FIG. 3 and schematically shows the area around the connecting portion that corresponds to the lead.

FIG. 6 is a partial enlarged perspective view schematically showing an area around a connecting portion that corresponds to a wire according to the embodiment.

FIG. 7 is a flowchart showing a manufacturing method of the liquid surface detection apparatus according to the embodiment.

FIG. 8 is a top view showing a terminal immediately after a press step according to the embodiment.

FIG. 9 is a front view showing the terminal immediately after the press step according to the embodiment.

FIG. 10 is a partial enlarged top view schematically showing a portion that corresponds to FIG. 4 in a state where molding dies and the terminal are fitted together in a positioning step according to the embodiment.

FIG. 11 is a partial enlarged top view schematically showing a molded article after removal thereof at a removing step according to the embodiment, indicating the portion that corresponds to FIG. 4.

FIG. 12 is a cross sectional view schematically showing a lead line connecting step according to the embodiment.

### DESCRIPTION OF EMBODIMENTS

Hereinafter, an embodiment will be described with reference to the accompanying drawings.

A liquid surface detection apparatus 100 of the embodiment is installed to an internal combustion engine of a vehicle and is placed in an inside of an oil pan (serving as a container) 1. The oil pan 1 is installed to a bottom surface of a cylinder block of the internal combustion engine. Engine oil, which is received in an inside of the oil pan 1, is supplied to corresponding respective parts of the engine through an oil pump of the vehicle and is thereafter returned to the oil pan 1 through an oil dropper 1a. In the present embodiment, a main unit 7 of the liquid surface detection apparatus 100 is placed below the oil dropper 1a, more specifically a location between the oil dropper 1a and an oil pan bottom portion 1b.

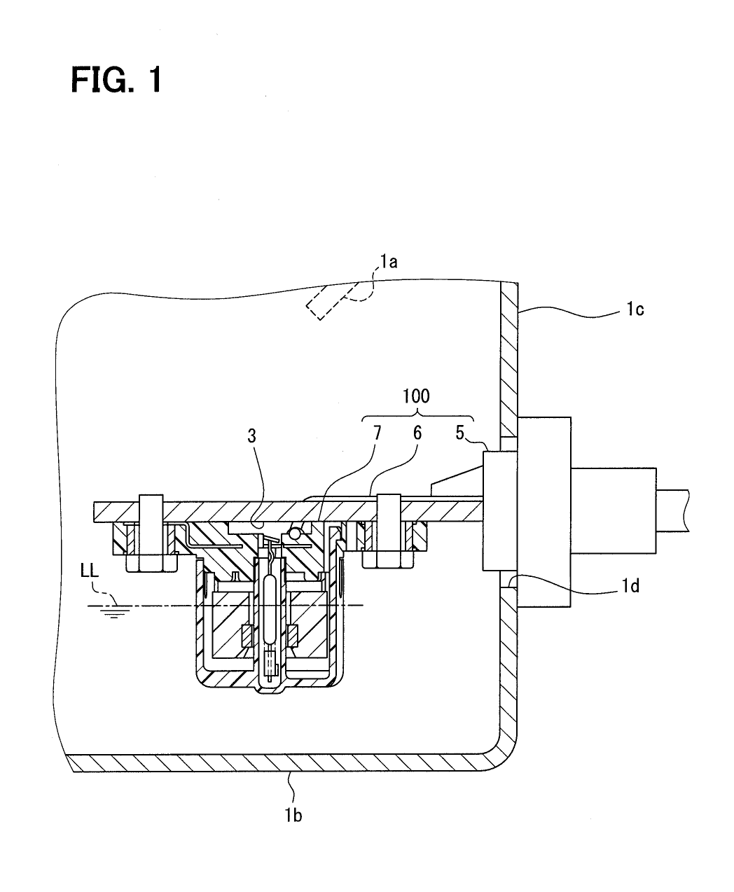

The liquid surface detection apparatus 100 includes a connector 5, the main unit 7 and a wire 6 as main components thereof. The connector 5 fluid-tightly closes an opening 1d, which is formed in an oil pan peripheral portion 1c. Also, the connector 5 is formed to be fittable to a mating-side connector for electrically connecting with an external on-vehicle device (e.g., a combination meter). The main unit 7 is fixed to the oil pan 1 through, for example, a bracket 3 in an installed state shown in FIG. 1. The main unit 7 is operable to sense a liquid surface level LL of the engine oil that is stored in the oil pan 1. The wire 6 is formed such that a surface of a conductive line, which is made of, for example, copper or brass, is covered with plating (e.g., tin-plating) and is sheathed with a dielectric material, such as silicone. The wire 6 electrically connects between the connector 5 and the main unit 7 and is placed along, for example, the bracket 3.

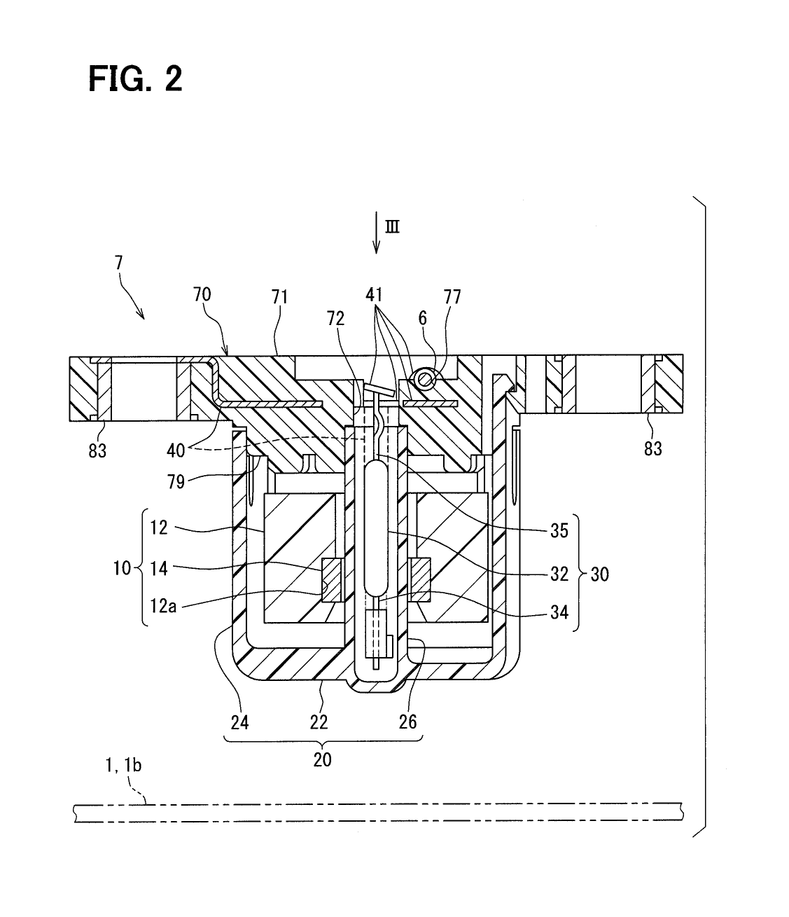

Hereinafter, the main unit 7 of the liquid surface detection apparatus 100 will be described with reference to FIGS. 2 to 6. The main unit 7 of the liquid surface detection apparatus 100 includes a float 10, a cover 20, a reed switch 30, a terminal 40 and a body 70.

As shown in FIG. 2, the float 10 includes a polymeric foam body 12 and a magnet 14 and is floatable on the liquid surface of the engine oil. The polymeric foam body 12 is made of a material, such as phenolic resin that is foamed and has a specific gravity that is smaller than that of the engine oil. A holding groove 12a, which is in an annular form, is formed along an inner peripheral side of the polymeric foam body 12. The magnet 14 is a permanent magnet made of, for example, ferrite and is shaped into a cylindrical tubular form. The magnet 14 is fitted into the holding groove 12a, so that the magnet 14 is held by the polymeric foam body 12.

With reference to FIG. 2, the cover 20 is made of synthetic resin, such as polyphenylene sulfide (PPS) resin, which is oil resistant, and the cover 20 is shaped into a bottomed cylindrical tubular form. The cover 20 includes a bottom wall 22, an outer tube 24 and an inner shaft 26, which are formed integrally as a one-piece body.

The bottom wall 22 is located on the oil pan bottom portion 1b side of the cover 20 that is furthermost from the body 70, and the bottom wall 22 is shaped into a circular disk form. The outer tube 24 is shaped into a cylindrical tubular form that projects from an outer peripheral portion of the bottom wall 22 toward the body 70. The inner shaft 26 is placed on a radially inner side of the outer tube 24 and is shaped into a cylindrical tubular form that projects from the bottom wall 22 toward the body 70.

In the cover 20, a distal end part of the outer tube 24 and a distal end part of the inner shaft 26 are fitted to the body 70, and the float 10 is installed around the inner shaft 26 and is thereby received between the inner shaft 26 and the outer tube 24. The float 10 follows the liquid surface level LL and is thereby guided along the inner shaft 26 to move upward or downward. Furthermore, the movement of the float 10 toward the oil pan bottom portion 1b is limited within a predetermined range through contact of the bottom wall 22 to the float 10.

As shown in FIG. 2, the reed switch 30 is a sensor element that senses a position of the float 10, which is moved along the inner shaft 26. The reed switch 30 includes a glass capsule 32 and a pair of leads 34, 35. The glass capsule 32 is shaped into a cylindrical tubular form, and the leads 34, 35 project in a form of a strip from two opposite ends, respectively, of the glass capsule 32. The reed switch 30 is inserted into an inside of the inner shaft 26 such that an axial direction of the glass capsule 32 extends in a top-to-bottom direction, and a portion of the reed switch 30 is placed in a through-hole 72 that is formed in the body 70. Specifically, the glass capsule 32 is shaped into a hollow cylindrical form and liquid-tightly receives opposed parts (end parts) of the leads 34, 35. The opposed parts of the leads 34, 35 are flexible and are opposed to each other while a predetermined gap is interposed between the opposed parts of the leads 34, 35. When a magnetic field, which is generated from the magnet 14, is applied to the opposed parts of the leads 34, 35, these opposed parts are magnetized to have opposite polarities, respectively, and are thereby magnetically attracted to each other. When these opposed parts contact with each other, the reed switch 30 is placed into an ON-state where an electric current is conductible between the leads 34, 35. In contrast, when the magnetic field of the magnet 14 is not sufficiently applied to the leads 34, 35, the opposed parts of the leads 34, 35 do not contact with each other, and thereby the reed switch 30 is placed into an OFF state.

With reference to FIG. 2, each of the terminals 40, 41 is formed by applying plating (e.g., tin plating) on a surface of, for example, brass, so that the terminal 40, 41 is formed as a strip made of an electrically conductive material. The terminals 40, 41 are insert-molded in the body 70, so that the terminals 40, 41 are held by the body 70 and are connected to the leads 34, 35, respectively. Specifically, the terminal 40 is received in the inner shaft 26 and extends to a position that is closer to the bottom wall 22 than the glass capsule 32. The terminal 40 is connected to and supports the lead 34, and the terminal 40 is also connected to a ground wire. In contrast, the other terminal 41 is connected to and supports the lead 35 at a location that is adjacent to the through-hole 72 of the body 70. The terminal 41 is also connected to the wire 6. In this way, a measurement signal of the reed switch 30 is outputted to the outside through the lead 35 and the wire 6, which serve as lead lines, respectively.

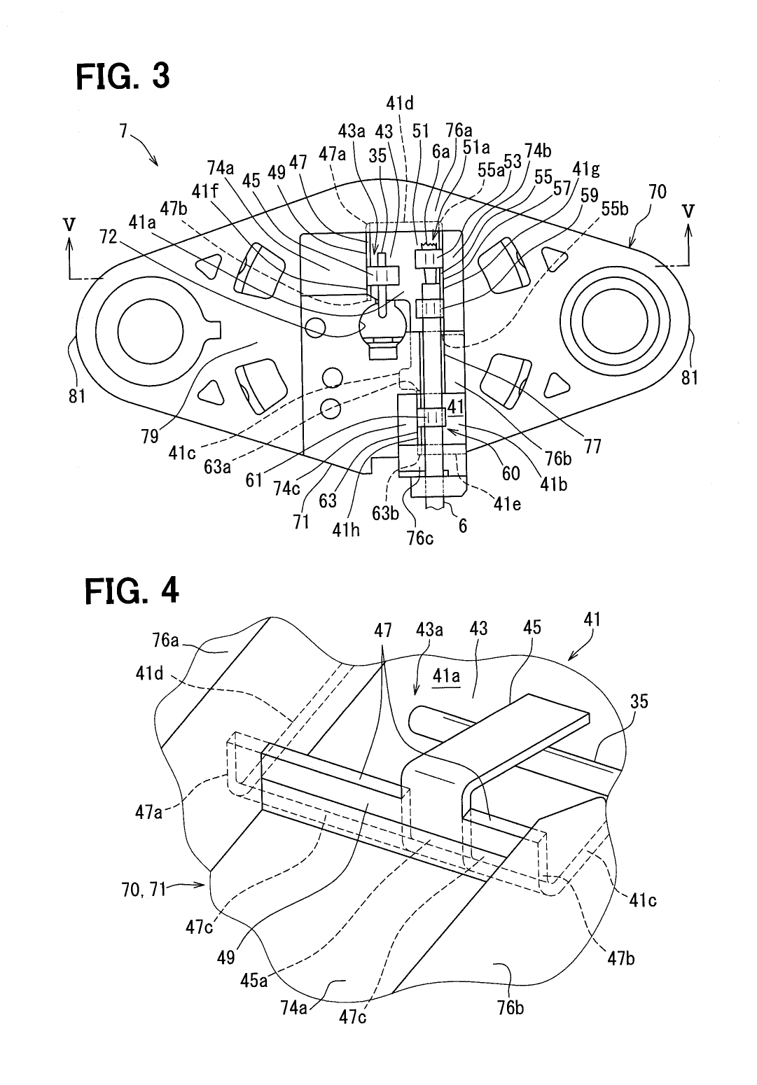

The terminal 41 will be described in detail below. As shown in FIG. 3, the terminal 41 includes a first exposed portion 41a and a second exposed portion 41b, which are exposed from the body 70 at an opposite side of the body 70 that is opposite from the oil pan bottom portion 1b. Furthermore, an intermediate covered portion 41c, which is embedded into the body 70, is formed between the first exposed portion 41a and the second exposed portion 41b. Also, a first covered portion 41d is formed at a location, which is adjacent to the first exposed portion 41a and is located on an opposite side of the first exposed portion 41a that is opposite from the intermediate covered portion 41c. Additionally, a second covered portion 41e is formed at a location, which is adjacent to the second exposed portion 41b and is located on an opposite side of the second exposed portion 41b that is opposite from the intermediate covered portion 41c.

The terminal 41 includes connecting portions 43, 51 respectively formed at two locations, bent portions 45, 53 respectively formed at two locations, projecting wall portions 47, 55 respectively formed at two locations, and a bent holding portion 59, which all correspond to the first exposed portion 41a. The bent portions 45, 53 correspond to the connecting portions 43, 51, respectively. The projecting wall portions 47, 55 correspond to the connecting portions 43, 51, respectively.

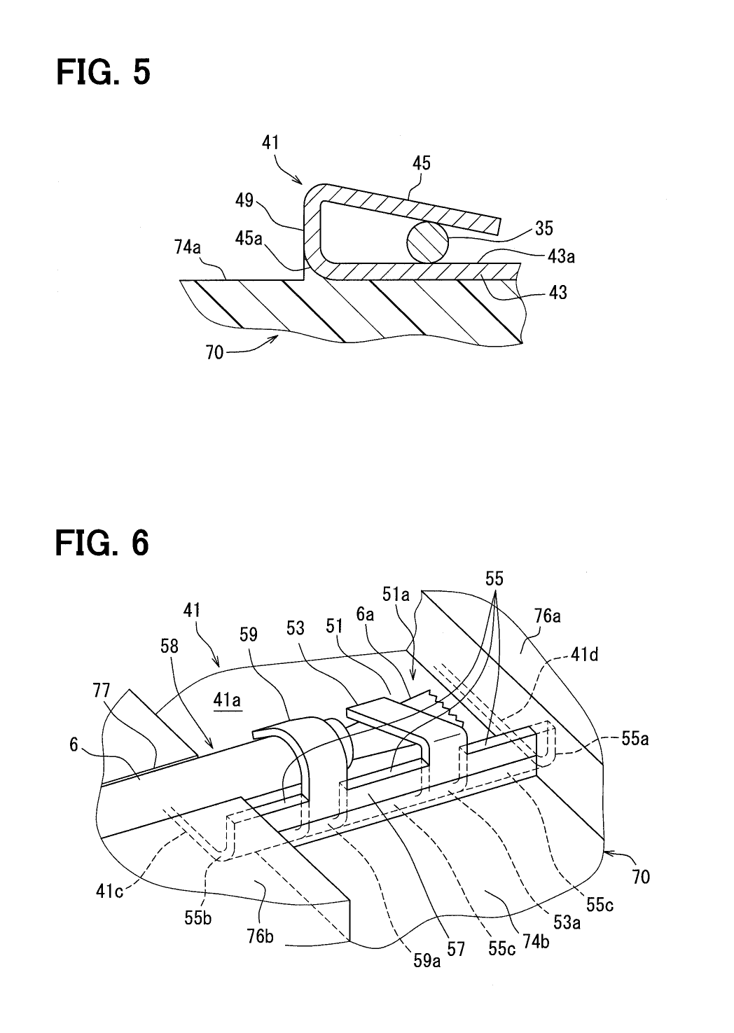

As shown in the magnified views of FIGS. 4 and 5, the connecting portion 43 is formed in a connecting area 43a of the terminal 41, which is in a form of a planar surface and is exposed from the body 70. The bent portion 45, which corresponds to the connecting portion 43, is formed continuously with the connecting area 43a and is in a form of a claw that is bent toward the side where the connecting area 43a is exposed. The bent portion 45 is bent about 180 degrees or more, so that a distal end of the bent portion 45 is opposed to the connecting portion 43. The lead 35 is clamped between the connecting portion 43 and the bent portion 45, so that the lead 35 is connected to the terminal 41.

Hereinafter, a side of the bent portion 45, which is located on an inner side of a curve of the bent portion 45 formed by the bending, will be referred to as a bending side, and a side of the bent portion 45, which is located on an outer side of the curve of the bent portion 45, will be referred to as a counter-bending side. The definitions of the bending side and the counter-bending side are also equally applied to the bent portion 53 and the bent holding portions 59, 61, which will be described later.

The projecting wall portion 47, which corresponds to the connecting portion 43, is formed continuously with the connecting area 43a together with a base of the bent portion 45, and the projecting wall portion 47 projects in a form of a standing wall from the connecting area 43a. Specifically, the projecting wall portion 47 is formed to hold the base of the bent portion 45 from two opposite sides, respectively, of the base of the bent portion 45. The projecting wall portion 47 linearly extends from the two opposite sides of the base of the bent portion 45 in an extending direction that extends along an outer edge 41f of the terminal 41, and one side end 47a of the projecting wall portion 47 reaches the first covered portion 41d. Furthermore, another side end 47b of the projecting wall portion 47 reaches the intermediate covered portion 41c. In the projecting wall portion 47, a wall surface 49, which is in a form of a planar surface, is formed in a side surface of the projecting wall portion 47, which is opposite from the connecting portion 43 such that the wall surface 49 continuously extends in the extending direction also along the bent portion 45. This wall surface 49 is set such that the wall surface 49 defines an angle, which is other than an acute angle, relative to an exposed surface of an extending portion 74a of the body 70. Particularly, in the present embodiment, this angle is set to be a right angle.

As shown in an enlarged view in FIG. 6, similar to the connecting portion 43, the connecting portion 51 is formed in a connecting area 51a of the terminal 41, which is in a form of a planar surface and is exposed from the body 70. At another outer edge 41g of the terminal 41 that does not intersect with the outer edge 41f, along which the projecting wall portion 47 extends, similar to the bent portion 45, the bent portion 53, which corresponds to the connecting portion 51, is formed continuously with the connecting area 51a and is in a form of a claw that is bent toward the side where the connecting area 51a is exposed. The bent portion 53 is bent about 180 degrees or more, so that a distal end of the bent portion 53 is opposed to the connecting portion 51. A distal end portion 6a of the wire 6 is clamped between the connecting portion 51 and the bent portion 53 in a state where the conductive line is exposed from the wire 6, so that the wire 6 is connected to the terminal 41.

The bent holding portion 59 is formed in a middle of the outer edge 41g, along which the wire 6 extends toward the bracket 3. The bent holding portion 59 is formed continuously with a holding area 58 that forms a common surface that is common with the connecting portion 51. Similar to the bent portion 53, the bent holding portion 59 is bent about 180 degrees, so that a portion of the wire 6, which is in the sheathed state, is clamped and held between the bent holding portion 59 and the holding area 58.

Similar to the projecting wall portion 47, the projecting wall portion 55, which corresponds to the connecting portion 43, is formed continuously with the connecting area 43a together with a base of the bent portion 53, and the projecting wall portion 55 projects in a form of a standing wall from the connecting area 43a. Specifically, the projecting wall portion 55 holds the base of the bent portion 53 from two opposite sides, respectively, of the base of the bent portion 53. The projecting wall portion 55 linearly extends from the two opposite sides of the base of the bent portion 53 in an extending direction that extends along the outer edge 41g of the terminal 41, and one side end 55a of the projecting wall portion 55 reaches the first covered portion 41d. Another side of the projecting wall portion 55, which is opposite from the one side end 55a, reaches a base of the bent holding portion 59 and further extends beyond the bent holding portion 59, so that another side end 55b of the projecting wall portion 55 reaches the intermediate covered portion 41c. Even in the projecting wall portion 55, a wall surface 57, which is in a form of a planar surface, is formed in a side surface of the projecting wall portion 55, which is opposite from the connecting portion 51 such that the wall surface 57 continuously extends in the extending direction also along the bent portion 53 and the bent holding portion 59. Similar to the wall surface 49, the wall surface 57 is set such that the wall surface 57 defines an angle, which is other than an acute angle, relative to an exposed surface of an extending portion 74b of the body 70. Particularly, in the present embodiment, this angle is set to be a right angle.

As shown in FIG. 3, the terminal 41 includes a bent holding portion 61 and a projecting wall portion 63, which correspond to the second exposed portion 41b. The bent holding portion 61 is formed along another outer edge 41h of the terminal 41, which is generally parallel to the outer edge 41g, such that the bent holding portion 61 is placed in a middle of an extending part that extends from the location, at which the wire 6 is held by the bent holding portion 59, toward the bracket 3. The bent holding portion 61 is formed continuously with a holding area 60. Similar to the bent holding portion 59, the bent holding portion 61 is bent about 180 degrees, so that a portion of the wire 6, which is in the sheathed state, is clamped and held between the bent holding portion 61 and the holding area 60. The projecting wall portion 63, which corresponds to the bent holding portion 61, is formed continuously with the holding area 60 together with a base of the bent holding portion 61, and the projecting wall portion 63 projects in a form of a standing wall from the holding area 60.

As shown in FIGS. 2 and 3, the body 70 is formed integrally with the terminal 41. The body 70 includes a dielectric portion 71, which is made of a dielectric material, such as PPS resin, and serves as a main part of the of the body 70. As a whole, the body 70 is shaped into a plate form. The body 70 includes the through-hole 72, the extending portion 74a, the extending portion 74b, an extending portion 74c, embedding portions 76a-76c and a flange portion 81. The extending portion 74a corresponds to the bent portion 45. The extending portion 74b corresponds to the bent portion 53 and the bent holding portion 59. The extending portion 74c corresponds to the bent holding portion 61. The embedding portions 76a-76c correspond to the covered portions 41c-41e, respectively.

The through-hole 72 is a hole that extends through the body 70 and is communicated with the inside of the inner shaft 26 of the cover 20. The through-hole 72 enables connection between the reed switch 30 and the terminal 41 by receiving the lead 35 through the through-hole 72.

As shown in FIGS. 3 to 5, the extending portion 74a, which corresponds to the bent portion 45, is securely joined to the terminal 41 without forming a gap between the extending portion 74a and the terminal 41 at fixing parts 45a, 47c of the terminal 41. The fixing part 45a is formed at a base side of a side surface of the bent portion 45 located on the counter-bending side. The fixing part 47c is formed at a base side of a side surface of the projecting wall portion 47 located on the counter-bending side. The extending portion 74a of the present embodiment is also securely joined to an opposite side (i.e., the oil pan bottom portion 1b side) of the connecting portion 43, which is opposite from the connecting area 43a. The extending portion 74a extends in a form of a plate toward an opposite side, which is opposite from the connecting portion 43, i.e., toward a side that is away from the terminal 41.

As shown in FIGS. 3 and 6, the extending portion 74b, which corresponds to the bent portion 53 and the bent holding portion 59, is securely joined to the terminal 41 without forming a gap between the extending portion 74b and the terminal 41 at fixing parts 53a, 59a, 55c of the terminal 41. The fixing part 53a is formed at a base side of a side surface of the bent portion 53 located on the counter-bending side. The fixing part 59a is formed at a base side of a side surface of the bent holding portion 59 located on the counter-bending side. The fixing part 55c is formed at a base side of a side surface of the projecting wall portion 55 located on the counter-bending side. The extending portion 74b of the present embodiment is also securely joined to an opposite side (i.e., the oil pan bottom portion 1b side) of the connecting portion 51, which is opposite from the connecting area 51a. The extending portion 74b extends in a form of a plate toward an opposite side, which is opposite from the connecting portion 43, i.e., toward a side that is away from the terminal 41.

As shown in FIG. 3, similar to the extending portions 74a-74b, the extending portion 74c, which corresponds to the bent holding portion 59, is securely joined to the terminal 41 without forming a gap between the extending portion 74c and the terminal 41 and extends in a form of a plate toward a side that is away from the terminal 41.

As shown in FIGS. 3, 5 and 6, the embedding portion 76a, which corresponds to the first covered portion 41d, is formed integrally with the extending portions 74a-74c. The one side end 47a of the projecting wall portion 47 and the one side end 55a of the projecting wall portion 55 are embedded in the embedding portion 76a. The embedding portion 76b, which corresponds to the intermediate covered portion 41c, is formed integrally with the extending portions 74a-74c. The other side end 47b of the projecting wall portion 47, the other side end 55b of the projecting wall portion 55 and one side end 63a of the projecting wall portion 63 are embedded in the embedding portion 76b. Furthermore, the embedding portion 76b forms a guide part 77, which is in a form of a groove and is located at an exposed part of the embedding portion 76b that is exposed on a side that is opposite from the oil pan bottom portion 1b. A portion of the wire 6, which is located between the bent holding portion 59 and the bent holding portion 61, is guided with the guide part 77. As shown in FIG. 3, the embedding portion 76c, which corresponds to the second covered portion 41e, is formed integrally with the extending portions 74a-74c, and another side end 63b of the projecting wall portion 63 is embedded in the embedding portion 76c.

The extending portions 74a-74c and the embedding portions 76a-76c of the body 70 form a partitioning wall 79 that is shaped into a circular disk form and partitions between the oil pan bottom portion 1b side and an opposite side, which is opposite from the oil pan bottom portion 1b. The float 10, which is placed in the inside of the cover 20, contacts the partitioning wall 79 in response to movement of the float 10 in the top-to-bottom direction, so that the movement of the float 10 toward the opposite side, which is opposite from the oil pan bottom portion 1b, is limited within a predetermined range. Furthermore, falling of liquid from the opposite side, which is opposite from the oil pan bottom portion 1b, on the float 10 is limited by the partitioning wall 79.

The flange portion 81 is formed integrally with the partitioning wall 79 such that the flange portion 81 surrounds an outer peripheral side of the partitioning wall 79. Installation rings 83, which are made of metal and are shaped into a cylindrical tubular form, are embedded in the flange portion 81 to secure the main unit 7 to the bracket 3 with screws inserted into the installation rings 83.

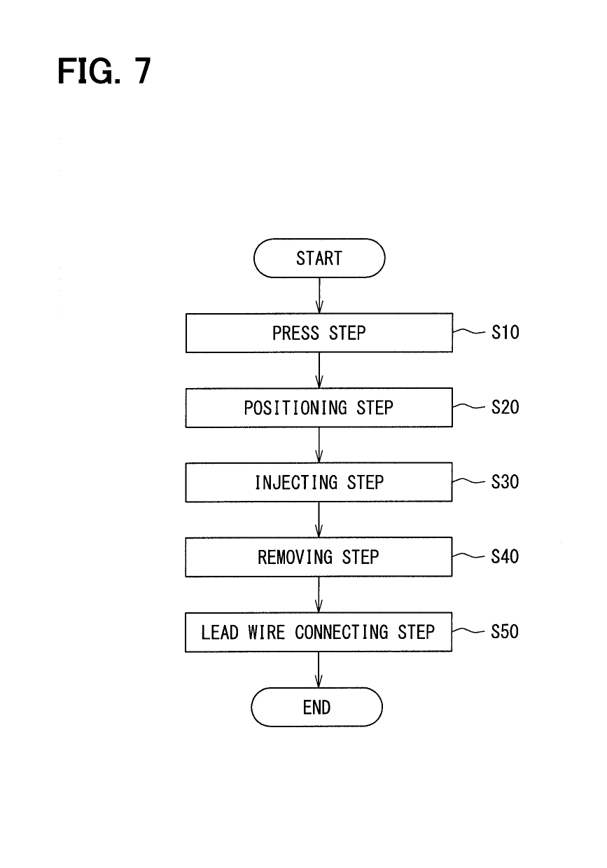

Now, a manufacturing method of the liquid surface detection apparatus 100 will be described with reference to a flowchart of FIG. 7 while focusing on particularly a method of integrally forming the terminal 41 and the body 70 together through use of molding dies 90, 92 that are used to mold the body 70, and a method of connecting the lead 35 and the distal end portion 6a of the wire 6 to the connecting portions 43, 51 of the terminal 41.

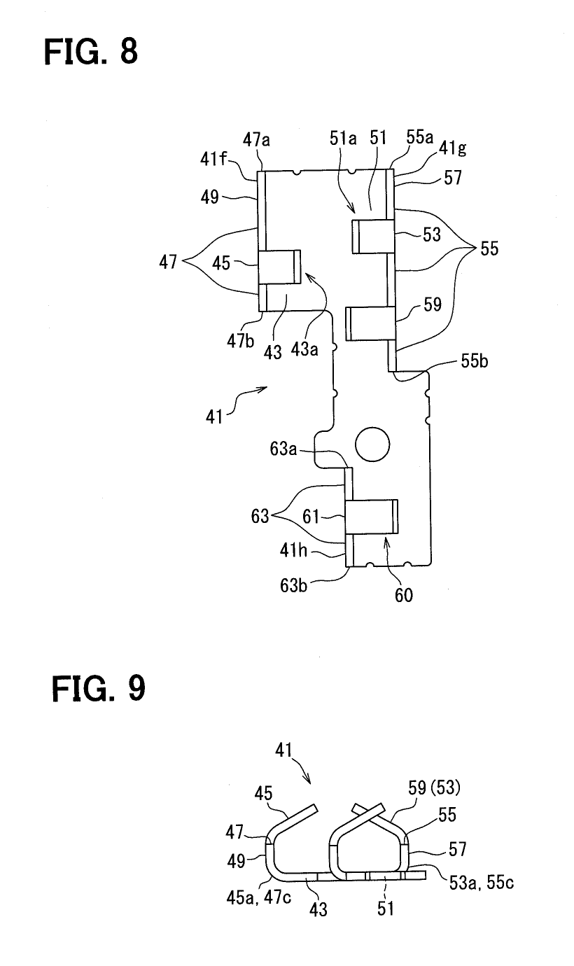

First of all, at a press step S10, the terminal 41 is formed through a press work. Specifically, a plate, which is made of an electrically conductive material, is clamped between press dies, which have corresponding recesses and projections, so that the terminal is formed in a form shown in FIGS. 8 and 9. At this time point, the bent portions 45, 53 and the bent holding portions 59, 61 are only partway bent relative to the operable states of the bent portions 45, 53 and the bent holding portions 59, 61 shown in FIGS. 3 to 6. In response to the transformation of the shape discussed above, irregular wrinkles are formed at sides of the bent portions 45, 53 and the bent holding portions 59, 61 as well as the side ends 47a-47b, 55a-55b, 63a-63b of the projecting wall portions 47, 55, 63. After the press process, plating (e.g., tin plating) is formed at the surface of the terminal 41 that is shaped in the form shown in FIGS. 8 and 9. This plating may be the same type as the plating formed on the lead 35 and the wire 6, such as the tin plating of the present embodiment.

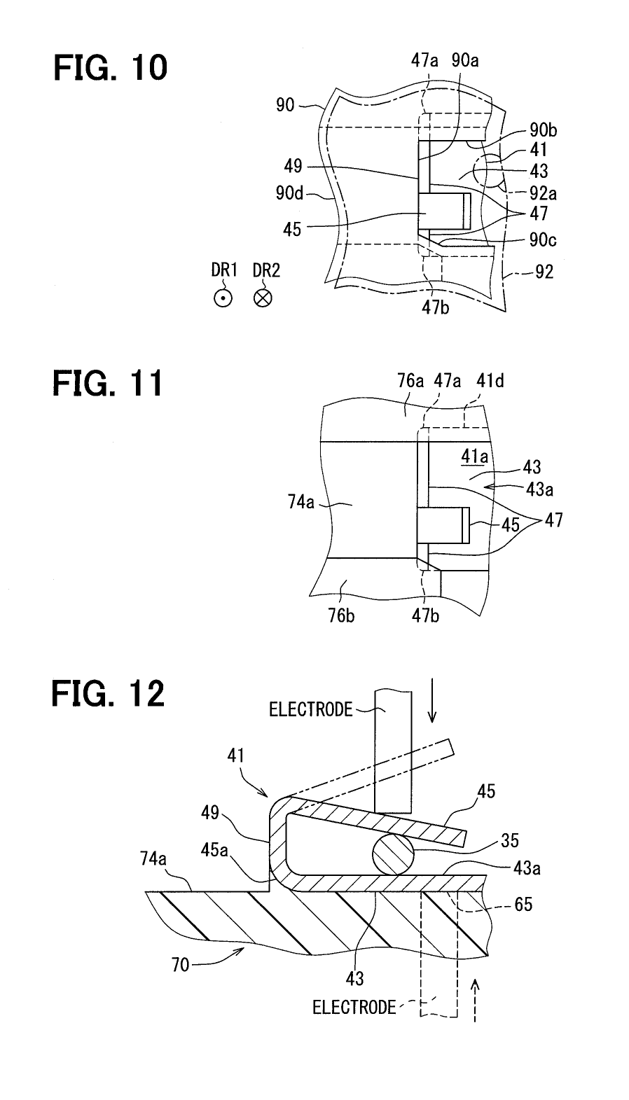

At a positioning step S20, which is executed after the press step S10, the molding dies 90, 92 and the terminal 41 are positioned such that the terminal 41 is held by the molding dies 90, 92. With reference to FIG. 10, the molding die 90 is fitted to the terminal 41 from the side, at which the terminal 41 is exposed from the body 70 (i.e., the side that is opposite from the oil pan bottom portion 1b in an installed state of the oil pan 1). The molding die 90 includes a wall surface contacting portion 90a, two wall crossing portions 90b, 90c and an extension forming portion 90d, which correspond to the bent portion 45.

The wall surface contacting portion 90a contacts the wall surface 49 of the projecting wall portion 55, which is in the form of the planar surface and is formed on the side that is opposite from the connecting portion 43. The wall surface contacting portion 90a is shaped in a form of a planar surface to avoid generation of a gap between the wall surface contacting portion 90a and the wall surface 49.

The wall crossing portion 90b contacts the terminal 41 such that the wall crossing portion 90b crosses the projecting wall portion 47 at a location between the bent portion 45 and the side end 47a. The wall crossing portion 90b is formed continuously and integrally with the wall surface contacting portion 90a in conformity with the shape of the projecting wall portion 47 and the shape of the connecting portion 43 in a manner that limits formation of a gap between the wall crossing portion 90b and the terminal 41. The wall crossing portion 90c contacts the terminal 41 such that the wall crossing portion 90c crosses the projecting wall portion 47 at a location between the bent portion 45 and the side end 47b in order to form the embedding portion 76b. The wall crossing portion 90c is formed continuously and integrally with the wall surface contacting portion 90a in conformity with the shape of the projecting wall portion 47 and the shape of the connecting portion 43 in a manner that limits formation of a gap between the wall crossing portion 90c and the terminal 41.

The extension forming portion 90d is formed to extend from the wall surface contacting portion 90a to the side that is opposite from the connecting portion 43. An extending surface of the extension forming portion 90d, which faces the oil pan bottom portion 1b, does not contact the terminal 41.

Furthermore, the molding die 90 also includes a wall surface contacting portion, two wall crossing portions and an extension forming portion for each of the bent portion 53 and the bent holding portions 59, 61 like in the case of the bent portion 45 discussed above.

The molding die 92 (see a dot-dash line in FIG. 10) is fitted with the terminal 41 from the side (i.e., the oil pan bottom portion 1b side in the installed state of the oil pan 1) that is opposite from the molding die 90. The molding die 92 contacts the molding die 90 at a location, which is on an outer side of an outer peripheral part of the partitioning wall 79 and an outer peripheral part of the flange portion 81, and a location, which corresponds to the through-hole 72. Furthermore, the molding die 92 is placed such that a majority of the molding die 92 does not contact the terminal 41. However, the molding die 92 includes a projecting contact portion 92a that contacts a corresponding location of the terminal 41, which is located on a side that is opposite from the connecting area 43a.

At an injecting step S30, which is executed after the positioning step S20, the dielectric material is injected between the molding die 90 and the molding die 92. Specifically, the PPS resin, which serves as the dielectric material and is fluidized upon heating thereof, is injected between the molding die 90 and the molding die 92. Due to the contact between the molding die 90 and the terminal 41, the dielectric material is injected at the counter-bending side of the terminal 41.

At a removing step S40, which is executed after the injecting step S30, the molding die 90 and the molding die 92 are removed away from each other after cooling of the dielectric material, so that the terminal 41 and the body 70, which are formed as a one-piece molded product as shown in FIG. 11, are removed from the molding dies 90, 92. FIG. 10 indicates a die removing direction DR1 of the molding die 90 and a die removing direction DR2 of the molding die 92.

At a lead line connecting step S50, which is executed after the removing step S40, as shown in FIG. 12, the lead 35 and the wire 6, which serve as the lead lines, are connected to the terminal 41. In the present embodiment, the lead 35 and the wire 6 are connected to the terminal 41 by electric heat fusing.

At the time of connecting the lead 35, the lead 35 is placed between the connecting portion 43 and the bent portion 45. Thereafter, one of two electrodes, each of which is in a form of a metal rod, is urged against the bent portion 45 from the side that is opposite from the connecting portion 43. In this way, the bent portion 45 is further bent from the form at the time of executing the press step S10, and thereby the lead 35 is clamped between the bent portion 45 and the connecting portion 43. Furthermore, the other one of the electrodes is urged against an exposed part 65 that is formed at the above-described corresponding location of the terminal 41 through the contacting of the projecting contact portion 92a to the terminal 41. When an electric current is applied between the two electrodes in the above-described state, a surface of the connecting portion 43 and the plating of the lead 35 are melted to join the lead 35 to the connecting portion 43.

At the time of connecting the wire 6, first of all, the sheathed portion of the wire 6 is placed at the corresponding part of the bent holding portion 59 and the corresponding part of the bent holding portion 61, and the distal end portion 6a of the wire 6 is placed between the connecting portion 51 and the bent portion 53. Thereafter, the one of the two electrodes, each of which is in the form of the metal rod, is urged against the bent portion 53 from the side that is opposite from the connecting portion 51. In this way, the bent portion 53 is further bent from the form at the time of executing the press step S10, and thereby the distal end portion 6a of the wire 6 is clamped between the bent portion 53 and the connecting portion 51. Furthermore, the other one of the electrodes is urged against the exposed part 65 that is formed at the above-described corresponding location of the terminal 41 through the contacting of the projecting contact portion 92a to the terminal 41. When an electric current is applied between the two electrodes in the above-described state, a surface of the connecting portion 51 and the plating of the distal end portion 6a are melted to join the wire 6 to the connecting portion 51. The bent holding portions 59, 61 are also bent to hold the wire 6.

Then, the float 10, the cover 20 and the body 70 are assembled together, and thereby the manufacturing of the liquid surface detection apparatus 100 is completed.

Now, advantages of the above-described embodiment will be described.

According to the present embodiment, the body 70, which includes the dielectric portion 71 made of the dielectric material, is formed integrally with the terminal 41 made of the electrically conductive material. At the connecting portions 43, 51 of the terminal 41, the connecting areas 43a, 51a are exposed from the body 70. The bent portions 45, 53, which are continuous with the connecting areas 43a, 51a, are bent on the side where the connecting areas 43a, 51a are exposed, so that each of the lead 35 and the wire 6, which serve as the lead lines, is connected between the corresponding bent portion 45, 53 and the corresponding connecting portion 43, 51. Each of the lead 35 and the wire 6 is connected between the corresponding connecting portion 43, 51 and the corresponding bent portion 45, 53, so that the lead 35 and the wire 6 are held in a manner that enables electrical conduction relative to the terminal 41, and thereby it is possible to limit occurrence of conduction failure.

In addition, the projecting wall portions 47, 55, each of which projects in the form of standing wall, are formed continuously with the connecting areas 43a, 51a, respectively, together with the base of the bent portions 45, 53. Because of the provision of the projecting wall portions 47, 55, even in the structure where the extending portions 74a-74b of the body 70 are securely joined to the fixing parts 45a, 53a of the side surfaces of the bent portions 45, 53, which are located on the counter-bending side, and the fixing parts 47c, 55c of the projecting wall portions 47, 55, it is possible to limit inflow of the dielectric material from the counter-bending side to the connecting areas 43a, 51a at the time of molding the body 70. Thereby, it is unlikely to occur that the lead 35 and the wire 6 are connected to the connecting areas 43a, 51a in the state where the dielectric material is left at the connecting areas 43a, 51a. Thus, the conduction failure is limited, and thereby the measurement signal of the reed switch 30, which serves as the sensor element, can be accurately outputted to the outside.

Since each of the extending portions 74a-74b, which are formed in the above described manner, extends toward the side that is opposite from the corresponding connecting portion 43, 51, the engine oil, which is the liquid, is less likely to pass through the body 70 and fall on the float 10. Therefore, it is possible to limit influence of the movement of the float 10, which is caused by the falling of the engine oil on the float 10, to the sensing result. Thus, the liquid surface level LL can be accurately sensed.

Furthermore, according to the present embodiment, the body 70 includes the embedding portions 76a-76b, in which the side ends 47a-47b, 55a-55b of the projecting wall portions 47, 55 are embedded. In the above-described form having the embedding portions 76a-76b, for example, it is not required to mold the body 70 in the state where the molding die 90 contacts the side ends 47a-47b, 55a-55b. Therefore, the degree of sealing at the time of molding is improved, so that it is possible to more reliably limit occurrence of the conduction failure, which would be otherwise caused by inflow of the dielectric material into the connecting areas 43a, 51a. As a result, the liquid surface level LL can be accurately sensed.

Furthermore, according to the present embodiment, the wall surface 49, 57, which is in the form of the planar surface, is formed in the side surface of the corresponding projecting wall portion 47, 55, which is opposite from the corresponding connecting portion 43, 51. For example, in the case of die-molding the body 70, the molding die 90 and the wall surface 49, 57 can contact with each other in the state where the degree of sealing between the molding die 90 and the wall surface 49, 57 is high. Therefore, the inflow of the dielectric material from each of the extending portions 74a-74b to the corresponding connecting portion 43, 51 can be reliably limited by the corresponding projecting wall portion 47, 55. Thus, the conduction failure can be limited, and the liquid surface level LL can be accurately sensed.

Furthermore, according to the present embodiment, the molding die 90 is placed to contact each projecting wall portion 47, 55 on the side that is opposite from the corresponding connecting portion 43, 51, and then the dielectric material is injected in the counter-bending side of the projecting wall portion 47, 55. Thereby, the body 70 is molded. In this way, at the time of injecting the dielectric material, the molding die 90 contacts the projecting wall portion 47, 55 on the side that is opposite from the corresponding connecting portion 43, 51. Therefore, it is possible to form the extending portions 74a-74b, each of which is securely joined to the counter-bending side of the corresponding projecting wall portion 47, 55, while limiting the inflow of the dielectric material to the connecting portions 43, 51 beyond the projecting wall portions 47, 55. In the liquid surface detection apparatus 100, which is manufactured in the above described manner, it is possible to limit the conduction failure, and the engine oil is less likely to pass through the body 70 and fall on the float 10. Thus, the liquid surface level LL can be accurately sensed.

Although the embodiment of the present disclosure has been described, the present disclosure should not be limited to the above embodiment and may be applied to various other embodiments without departing form the scope of the present disclosure. Hereinafter, modifications of the above embodiments will be described.

Specifically, as a first modification, each of the projecting wall portions 47, 55 may extend only from one side of the base of the bent portion 45, 53 as long as the bent portion 45, 53 is formed continuously from the connecting area 43a, 51a together with the base of the corresponding bent portion 45, 53.

As a second modification, the body 70 may not include the embedding portions 76a-76b, in which the side ends 47a-47b, 55a-55b of the projecting wall portions 47, 55 are embedded. Furthermore, at least a portion of the side end(s) 47a-47b, 55a-55b of the projecting wall portion 47, 55 may be exposed from the body 70.

As a third modification, the wall surface 49, 57 may be in another form, which is other than the form of the planar surface.

As a fourth modification, it may not be necessary to provide the bent portion, the projecting wall portion and the extending portion to all of the connecting portions as long as at least one of the connecting portions is provided with the bent portion, the projecting wall portion and the extending portion.

As a fifth modification, another type of synthetic resin, which is other than the PPS resin, may be used as the dielectric material. Furthermore, for example, rubber or ceramic may be used as an example of another material, which is other than the synthetic resin.

As a sixth modification, another element, which is other than the reed switch 30, such as a Hall element, may be used as the sensor element as long as such an element can sense the position of the float 10.

As a seventh modification, at the lead line connecting step S50, the lead 35 or the wire 6 may be connected by using another method, which is other than the electric heat fusing, such as spot welding.

As an eighth modification, the application subject of the present disclosure should not be limited to the sensing of the liquid surface level LL of the engine oil. The present disclosure may be applied to a liquid surface detection apparatus to be installed to a container for another type of liquid such as brake fluid, engine coolant, or fuel installed to the vehicle. Furthermore, the present disclosure may be applied to a liquid surface detection apparatus to be installed to a container of various types of consumer equipment, transportation equipment or the like. That is, the application subject of the present disclosure should not be limited to the liquid surface detection apparatus 100 that is placed on the lower side of the oil dropper 1a. As one example of this, the liquid surface detection apparatus of the present disclosure can have the above advantages even for falling of liquid droplets adhered to a ceiling portion of a container in the case where the container has the ceiling portion.

While the present disclosure has been described with reference to various exemplary embodiments thereof, it is to be understood that the present disclosure is not limited to the disclosed embodiments or constructions. To the contrary, the present disclosure is intended to cover various modifications and equivalent arrangements. In addition, while the various elements of the present disclosure are shown in various combinations and configurations, which are exemplary, other combinations and configurations, including more, less or only a single element, are also within the spirit and scope of the present disclosure.

What is claimed is:

1. A liquid surface detection apparatus for sensing a liquid surface level of liquid stored in a container, comprising:
a float that floats on the liquid;
a sensor element that senses a position of the float;
a terminal that is made of an electrically conductive material, wherein a lead line, which outputs a measurement signal of the sensor element to an outside, is connected to the terminal; and
a body that is formed integrally with the terminal and includes a dielectric portion, which is made of a dielectric material, wherein:
the terminal includes:
a connecting portion that is provided in a connecting area of the terminal, which is exposed from the body;
a bent portion that is continuous with the connecting area, wherein the bent portion is bent on a bending side where the connecting area is exposed, so that the lead line is connected between the bent portion and the connecting portion; and
a projecting wall portion that is formed continuously with the connecting area together with a side of a base of the bent portion, wherein the projecting wall portion projects in a form of a standing wall from the connecting area; and
the body includes an extending portion that is securely joined to:
a fixing part of a side surface of the bent portion located on a counter-bending side of the bent portion that is opposite from the bending side of the bent portion; and
a fixing part of the projecting wall portion; and
the extending portion extends from the fixing part of the side surface of the bent portion and the fixing part of the projecting wall portion toward a side that is opposite from the connecting portion.

2. The liquid surface detection apparatus according to claim 1, wherein the body includes an embedding portion, into which a side end of the projecting wall portion, is embedded.

3. The liquid surface detection apparatus according to claim 1, wherein a wall surface, which is in a form of a planar surface, is formed in a side surface of the projecting wall portion, which is opposite from the connecting portion.

4. A manufacturing method for manufacturing the liquid surface detection apparatus of claim 1 through use of a molding die that molds the body, comprising:
a positioning step of positioning the molding die such that the molding die contacts to an opposite side of the projecting wall portion, which is opposite from the connecting portion; and
an injecting step of injecting the dielectric material to the counter-bending side after the positioning step.
